(19) United States
(12) Patent Application Publication
(10) Pub. No.: US 2024/0036931 A1
(43) Pub. Date: Feb. 1, 2024

(54) Transferring Applications Between Execution Nodes

(71) Applicant: ABB Schweiz AG, Baden (CH)

(72) Inventors: Pablo Rodriguez, Birkenau (DE); Heiko Koziolek, Karlsruhe (DE); Andreas Burger, Weingarten (DE); Julius Rueckert, Langen (DE)

(73) Assignee: ABB Schweiz AG, Baden (CH)

(21) Appl. No.: 18/486,536

(22) Filed: Oct. 13, 2023

Related U.S. Application Data
(63) Continuation of application No. PCT/EP2022/059618, filed on Apr. 11, 2022.

(30) Foreign Application Priority Data
Apr. 13, 2021 (EP) 21167970.9
Apr. 29, 2021 (EP) 21171164.3

(51) Int. Cl. G06F 9/50

(52) U.S. Cl. CPC G06F 9/5044; G06F 9/5072; G06F 2209/503; G06F 2209/501; G06F 2209/5014

(57) ABSTRACT

A method for managing the transfer of a live containerized stateful process automation application from a source node to a target node of a process control system includes obtaining data relating to execution of the application at the source node and deriving from the data an application execution profile; obtaining an evaluation of available computing resources at the target node; determining feasibility of the transfer by comparing the available computing resources to the application execution profile; and in response to the transfer being determined to be feasible, initiating the transfer of the application from the source node to the target node.

### CROSS-REFERENCE TO RELATED APPLICATIONS

The instant application claims priority to International Patent Application No. PCT/EP2022/059618, filed on Apr. 11, 2022, and to European Patent Application Nos. 21167970.9, filed Apr. 13, 2021, and 21171164.3, filed Apr. 29, 2021, each of which is incorporated herein in its entirety by reference.

### FIELD OF THE DISCLOSURE

The present disclosure generally relates to methods and systems for managing the transfer of a live application from a source node to a target node of a process control system.

### BACKGROUND OF THE INVENTION

In order to gain flexibility in heterogeneous process control systems, containerization and virtualization helps in the portability and isolation of applications. It is expected that many plant devices can host control application runtimes and that virtualized runtime environments such as on-premise compute clusters will be available in the future. Therefore, the deployment of applications can be done in plentiful ways depending on the devices used in the process control system and the current availability of resources. Besides deployment to dedicated hardware devices, deployments to virtualized environments (e.g., virtual machines, container hosts) can be done.

During redeployment/transfer of a control application from execution node to execution node there is a non-neglectable risk that the application will not run in the destination node as it did in the source node. This can be caused by destination nodes not known at design time that are dynamically added to a cluster of nodes. These nodes possibly have different hardware specifications than the source node. This can, for example, mean that the application could not meet its defined cyclic execution time or crash because of a lack of memory on a less capable destination host. Also, the transfer via the network (e.g., crossing multiple hops) can take too long, which can also result in a miss in the cyclic execution time. In the worst case, this can affect the controlled physical process and produce significant production loses, because of reduced production quality or a stop of production. Even damage to equipment or harm to human workers would be conceivable. Moreover, the conditions of the execution environment at runtime may vary from the expected conditions at design time. As a result, the current performance of the destination node(s) and the process control system in terms of available compute, memory, and networking resources might be insufficient to guarantee seamless control application transfer and execution.

### BRIEF SUMMARY OF THE INVENTION

The present disclosure generally describes systems and methods for more effective transfer of applications from source nodes to target nodes of a process control system.

According to a first aspect, there is provided a computer-implemented transfer management method for managing the transfer of a live application from a source node to a target node of a process control system. The method comprises: obtaining data relating to execution of the application at the source node and deriving from the data an application execution profile; obtaining an evaluation of available computing resources at the target node; determining feasibility of the transfer by comparing the available computing resources to the application execution profile; and in response to the transfer being determined to be feasible, initiating the transfer of the application from the source node to the target node.

### BRIEF DESCRIPTION OF THE SEVERAL VIEWS OF THE DRAWING(S)

FIG. 1 is a block diagram of a system for transfer of control applications in a containerized environment in accordance with the disclosure.

FIG. 2 is a block diagram of a computing device that can be used in accordance with the systems and methods disclosed herein.

### DETAILED DESCRIPTION OF THE INVENTION

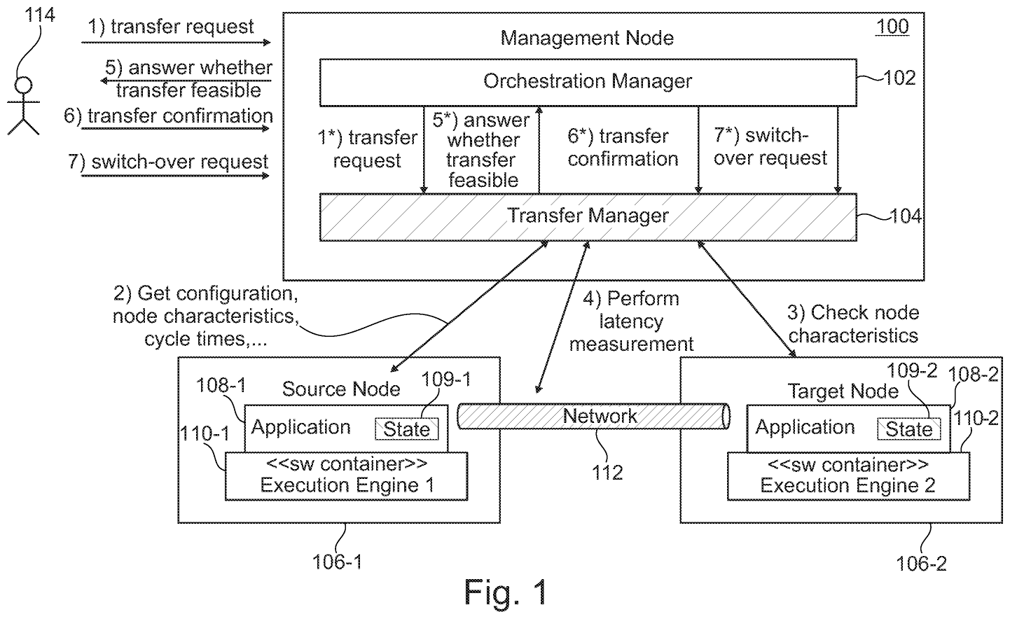

FIG. 1 shows applications 108 running on the execution engines 110 of distributed control nodes 106 of a distributed control system. Each application 108 is a program implementing a control algorithm for controlling one or more field devices (not shown) regulating an industrial process. The applications 108 can be implemented using one of the five IEC 61131-3 programming languages (Structured Text, Function Block Diagrams, Instruction Lists, Sequential Function Charts, Ladder Logic), for example. During execution, each application 108 carries an internal state 109, for example the value of counter variables, intermediate calculations, or timers. As is typical for process automation applications, there may be thousands of variables making up the internal state 109, which thus may consume large amounts of memory. The applications 108 may be referred to as stateful containerized applications, control (logic) applications, and/or process automation applications. The applications 108 may be implemented by automation engineers using an application engineering tool (not shown).

The field devices for regulating the industrial process may comprise one or more sensors and/or actuators, for controlling for example the temperature and flow in an oil pipeline, the filling level of a chemical reactor, or (as a PID controller) controlling gas flow in a boiler. The field devices are connected to the nodes 106 via a network 112. The sensors periodically send updated values (e.g., temperature is 70 degrees) as input signals to the respective application 108, while the actuators continuously listen for output signals from that application 108 (e.g., close valve to 20%).

Each execution engine 110 provides a runtime environment capable of cyclic execution of applications 108 (e.g., according to IEC 61131-3). The runtime periodically receives the input signals from the respective field device (e.g., once every 1-100 ms), executes the corresponding control algorithm on the input signals thereby to generate output signals, and sends the output signals to that field device using the same cycle time.

There is sometimes the need for applications to be redeployed to other nodes. Referring to FIG. 1, the application 108-1 is to be transferred from the source node 106-1 to the target node 106-2. Such flexible deployment may be performed for example to optimize distribution of workload (e.g. CPU load, memory load) across the nodes 106, to update the applications 108 or the execution engines 110, or to test changes in the applications 108 or execution engines 110. As is known in the art, an updated application 108-2 is run on the target node 106-2 in parallel with the original application 108-1. The inputs and outputs (I/Os) of the updated application 108-2 are compared with those of the original application 108-1. If the results of the comparison are acceptable, a switchover to the updated application 108-2 is triggered. To update the application 108-2, the state 109-1 of the original application 108-1 (or a predefined minimal set of that state) is transferred over the network 112.

Disclosed herein are systems and methods for safely moving and optionally changing control applications between nodes in a control system in a containerized environment without having a definition of the capabilities of the process control system nodes at design time. The state of the control application is also managed in the migration or transfer process. Therefore, the applications can be moved and optionally changed (LEG) without stopping or pausing them and while meeting real-time execution requirements. Real-time requirements for the execution can thereby be met and guaranteed during and after the transfer. Additionally, the same invention can be used for the updates of firmware (e.g., application execution engine, real-time operating system) or any other hardware/software component of an execution node in cases where no change of the control application is required.

FIG. 1 illustrates migration of control applications in a containerized environment. A transfer manager 104, implemented in this example as a software agent on a management node 100, performs a transfer precheck on transfer requests. This precheck can include checks for available resources (e.g., CPU time, memory, storage, network capacity) or even active measurements to verify resource availability. If the results from the precheck are positive, the transfer can be approved either manually by a user 114 or automatically by an orchestration manager 102. In addition, the transfer manager 104 can issue resource reservations or block resources after a positive precheck to ensure their availability for the transfer and execution on the target node. The transfer manager 104 may provide a user interface for interaction with the user 114, for example to display information and to receive user commands. The transfer manager as described herein may alternatively be referred to as an update manager or a deployment manager.
In step 1) of FIG. 1, the transfer manager 104 receives a transfer request from the user 114.
In step 2), the transfer manager 104 determines from the source node 106-1 those characteristics of the control application 108-1 to be transferred which are required to build an application execution profile (including, e.g., cycle time, control application configuration, execution priority, offset, size of control application state, etc.). On-demand application monitoring is thus performed to derive a load profile. This may comprise any one or more of: retrieving CPU utilization and memory footprint from the source node 106-1; retrieving average cycle time from a source execution engine 110-1 of the source node 106-1 (e.g., via vertical communication OPC UA server for Ac800M engine); retrieving jitter from the source execution engine 106-1.
In step 3), the transfer manager 104 determines properties of the target node 106-2 including for example standard benchmark application data.
In step 4), the transfer manager 104 optionally performs latency and/or bandwidth measurements on the network 112 connecting the source node 106-1 to the target node 106-2, calculated for example on the basis of a ping sent to one or more of the nodes 106, and optionally also checks the ability and capacity to issue network resource reservations.
In steps 3) and 4), on-demand benchmarking of the target node 106-2 and the network 112 for a given control application state size and application profile are thus performed. Packages able to provide such benchmarking include, for example, Cyclictest, Jitterdebugger, Tshark.
In step 5), the transfer manager 104 calculates the feasibility of the transfer without stopping the control application and provides the results to the user 114. The transfer manager 104 may issue and optionally also verify resource reservations based on the application execution profile and the required network resources. Resource reservations may comprise, for example, reservations of compute resources (such as CPU cores or execution time) and/or memory resources at the target node 106-2. Network resources (e.g. network capacity, bandwidth, paths, QoS, queue configurations) can be reserved using any available reservation mechanism provided by the network 112. One example includes the use of Ethernet/TSN mechanisms to reserve network capacity for the state transfer. Other examples of resource reservation mechanisms are provided by Linux cgroups, the IEEE 802.1Q Multiple Stream Reservation Protocol (MSRP), or the IEEE 802.1Q Multiple Registration Protocol (MRP).
In step 6), if the transfer feasibility is assessed positively, the user 114 confirms the start of the transfer. The transfer manager 104 transfers the control application configuration and the control application state from the source node 106-1 to the target node 106-2. The transfer manager 104 may then verify that the control application 108-2 now running on an execution engine 110-2 of the target node 106-2 is generating the same results as the control application 108-1 running on an execution engine of the source node 106-1. The results of the verification may then be provided to the user 114.
In step 7), the user 114 optionally issues a switchover request to the target node 106-2. Alternatively, the switchover may follow automatically, for example in response to positive verification that the transferred control application 108-2 is running as expected. The transfer manager 104 may instruct deletion of the original control application 108-1 on the source node 106-1 and may release resource reservations that are no longer required.

Instead of relying on manual input from the user 114, such input may be provided automatically by the orchestration manager 102. In this regard, FIG. 1 shows, in step 1*), the orchestration manager 102 issuing the transfer request and receiving the indication of transfer feasibility in step 5*). In step 6*), the orchestration manager 102 confirms the transfer and issues the switchover request in step 7*). The ability of the orchestration manager 102 to automatically migrate control applications without human intervention may be based on predefined rules.

Furthermore, although certain steps have been described as being taken by the transfer manager 102, it will be understood that any suitable entity or combination of entities may perform those steps. For example, verifying the transfer may be performed by the user 114 and/or by the orchestration manager 102.

Moreover, although the above disclosure relates to the transfer of control applications, it will be appreciated that any applications may be so transferred, for example firmware updates for the nodes.

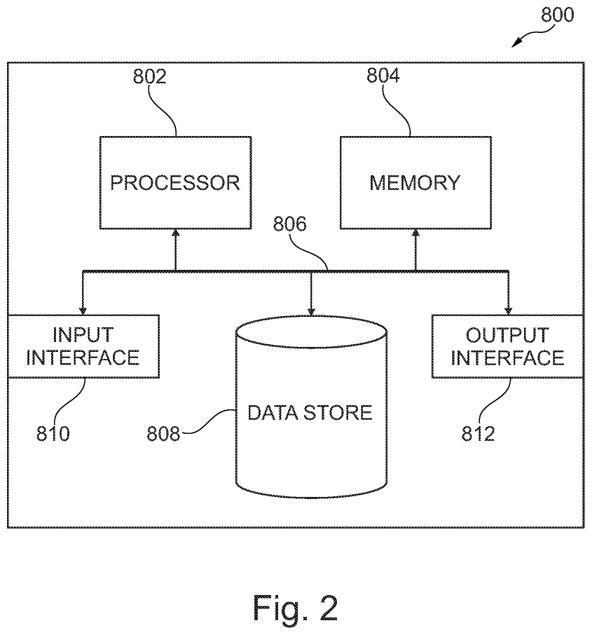

Referring now to FIG. 2, a high-level illustration of an exemplary computing device 800 that can be used in accordance with the systems and methodologies disclosed herein is illustrated. The computing device 800 includes at least one processor 802 that executes instructions that are stored in a memory 804. The instructions may be, for instance, instructions for implementing functionality described as being carried out by one or more components discussed above or instructions for implementing one or more of the methods described above. The processor 802 may access the memory 804 by way of a system bus 806. In addition to storing executable instructions, the memory 804 may also store conversational inputs, scores assigned to the conversational inputs, etc.

The computing device 800 additionally includes a data store 808 that is accessible by the processor 802 by way of the system bus 806. The data store 808 may include executable instructions, log data, etc. The computing device 800 also includes an input interface 810 that allows external devices to communicate with the computing device 800. For instance, the input interface 810 may be used to receive instructions from an external computer device, from a user, etc. The computing device 800 also includes an output interface 812 that interfaces the computing device 800 with one or more external devices. For example, the computing device 800 may display text, images, etc. by way of the output interface 812.

It is contemplated that the external devices that communicate with the computing device 800 via the input interface 810 and the output interface 812 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 800 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 800 may be a distributed system. Thus, for instance, several devices may be in communication by way of a network connection and may collectively perform tasks described as being performed by the computing device 800.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

It will be appreciated that the aforementioned circuitry may have other functions in addition to the mentioned functions, and that these functions may be performed by the same circuit.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features.

It has to be noted that embodiments of the invention are described with reference to different categories. In particular, some examples are described with reference to methods whereas others are described with reference to apparatus. However, a person skilled in the art will gather from the description that, unless otherwise notified, in addition to any combination of features belonging to one category, also any combination between features relating to different category is considered to be disclosed by this application. However, all features can be combined to provide synergetic effects that are more than the simple summation of the features.

While the invention has been illustrated and described in detail in the drawings and foregoing description, such illustration and description are to be considered exemplary and not restrictive. The invention is not limited to the disclosed embodiments. Other variations to the disclosed embodiments can be understood and effected by those skilled in the art, from a study of the drawings, the disclosure, and the appended claims.

The word “comprising” does not exclude other elements or steps.

The indefinite article “a” or “an” does not exclude a plurality. In addition, the articles “a” and “an” as used herein should generally be construed to mean “one or more” unless specified otherwise or clear from the context to be directed to a singular form.

A single processor or other unit may fulfil the functions of several items recited in the claims.

The mere fact that certain measures are recited in mutually different dependent claims does not indicate that a combination of these measures cannot be used advantageously.

A computer program may be stored/distributed on a suitable medium, such as an optical storage medium or a solid-state medium supplied together with or as part of other hardware, but may also be distributed in other forms, such as via the internet or other wired or wireless communications systems.

Any reference signs in the claims should not be construed as limiting the scope.

Unless specified otherwise, or clear from the context, the phrase “A and/or B” as used herein is intended to mean all possible permutations of one or more of the listed items. That is, the phrase “X comprises A and/or B” is satisfied by any of the following instances: X comprises A; X comprises B; or X comprises both A and B.

Advantageously, transfer management as described herein enables applications to be moved to new or different hardware nodes without stopping or pausing them, thus providing for zero downtime. Many different use cases are supported, such as hardware maintenance scenarios, software/hardware update/upgrade scenarios, scaling scenarios in which an application is transferred to a more powerful hardware node to deal with (temporarily) increased loads, and many more.

Optionally the application can be changed, for example as part of a method of testing changes in a control application such as Load Evaluate and Go (LEG), whereby the user can evaluate and then accept or revert changes without a second download of the control application. The transfer management is able to provide for safe execution of the control applications and monitoring of the health of the control applications. In case a safe transfer is not possible, this may be indicated beforehand. If a safe transfer is possible, resources can be reserved, leading to deterministic transfer behavior even in case of a temporarily interfering load on the system, including the network. High availability of control application execution is provided. If a node needs to be stopped, the control application can be moved to available nodes in the process control system. These nodes can be dedicated hardware nodes, shared nodes in a data center, or any other type of nodes with spare capacity to take over execution of the application.

As used herein, “obtaining” data may mean undertaking monitoring to gather that data or receiving the results of such monitoring.

Advantageously, the transfer management method may comprise obtaining not just an evaluation of available computing resources at the target node, but also an evaluation of available network resources connecting the source node to the target node. In this case, determining feasibility of the transfer may further comprise comparing the available network resources to the application execution profile. Obtaining the evaluation of available network resources may comprise obtaining latency and/or bandwidth measurements relating to communications between the source and target nodes. In this way, transfer feasibility may be more accurately determined.

Determining feasibility of the transfer may comprise determining the feasibility based on one or more thresholds, performance indicators, or other factors. For example, determining the feasibility of the transfer may comprise determining that the transfer is feasible (i) if the available computing resources are sufficient, (ii) if the available network resources are sufficient, or more preferably both (i) and (ii). Stated differently, determining the feasibility of the transfer comprises determining that the transfer is infeasible if either the available computing resources or available network resources are too low or are insufficient. Whether resources are sufficient may be determined on the basis of one or more thresholds and associated rules, for example.

Steps may be taken to visualize feasibility of the transfer. For example, the method may further comprise predicting one or more performance indicators relating to execution of the control application at the target node. Transfer feasibility may then be determined on the basis of such performance indicators. Predicting the one or more performance indicators may comprise running one or more benchmarks on the computing resources, on the network resources, or on both. Running the one or more benchmarks may comprise one or more of the following operations: run “cyclictest” to determine max jitter; run “ping/traceroot” to determine network latency; run “upower” to determine power usage; run “dd” to determine storage performance. The method may comprise running the one or more benchmarks while running a copy of a container containing the application on the target node, without writing outputs from the copy to the process control system.

The transfer of the application could be done between devices of the same type or to another device with different capabilities. In the simple case involving transfer to the same device type, determining feasibility may simply comprise checking the current CPU load and memory against the actual needs to determine if there is enough capacity. Additionally, network performance may be checked, to check that the network can handle the additional traffic and that temporal conditions can be met. If both conditions of execution and network are fulfilled, the transfer can be done. In case the transfer is done to another device type, determining feasibility may comprise profiling the target device. In any case, information concerning CPU capacity, CPU utilization and memory usage may be provided by the OS of the node in question. For the network, the time required for messages to be transmitted may be measured, along with e.g. the bandwidth among other parameters in order to evaluate the network.

By “application execution profile” is meant a collection of one or more parameters concerning execution of the application. For example, the application execution profile may specify one or more of i) a CPU utilization of the application at the source node; ii) a memory footprint of the application at the source node; iii) an average cycle time of an execution engine at the source node; iv) jitter at the source node execution engine; v) a size of a state of the application; vi) execution priority; vii) a configuration of the application; viii) offset (e.g. by how many milliseconds from the start of the cycle should the start of the application be delayed). Obtaining the evaluation of available computing resources at the target node may comprise obtaining output from benchmarking tools to determine the capabilities of the target node. Suitable benchmarking tools include one or more of i) Cyclictest; ii) Jitterdebugger; iii) Tshark.

By “initiating the transfer” is meant that the transfer is started by the transfer manager, that the transfer manager instructs another entity to start the transfer, and/or that preparatory steps to ensure that the transfer takes place are taken. For example, the transfer may be started and completed by the transfer manager or the transfer manager may instruct a transfer orchestrator to complete the transfer. Initiating the transfer may further comprise issuing resource reservations for the transfer. Issuing resource reservations may comprise issuing a computing resource reservation to the target node to reserve computing resources for execution of the application following the transfer. The computing resources to be reserved comprise one or more processor resources and/or one or more memory resources. Issuing resource reservations may further comprise issuing a network resource reservation to a network management system to reserve network resources for the transfer. The network resources comprise one or more of network capacity, bandwidth, and at least one network path. The transfer management method may further comprise verifying that the resources have been reserved before determining that the transfer is feasible. The resource reservations may be issued using one or more of i) Linux cgroups; ii) IEEE 802.1Q Multiple Stream Reservation Protocol; iii) IEEE 802.1Q Multiple Registration Protocol, for example. The transfer management method may further comprise releasing resource reservations which are no longer required following the transfer. In any of these ways, the transfer management method helps in ensuring a deterministic and resource-effective transfer.

The transfer may comprise transferring a state of the application. The state may remain unaltered during the transfer. Alternatively, transferring the state of the application may comprise introducing one or more alterations to the state during the transfer. In one example, using LEG, an engineer may modify the application (by introducing small changes) and, instead of using the classical download to the same device, allocate the modified application to another device and evaluate the results. If the results of the modified application are acceptable, the engineer may accept the changes, switch the execution to the new application and delete the old one. The transfer may comprise handing over execution of the application from the source node to the target node without stopping the execution. In another example, introducing one or more alterations to the state during the transfer comprises identifying a first part of the application state which can be transferred independently of a second part of the application state; performing a first partial transfer by transferring the first part of the application state from the source node to the target node; and performing a second partial transfer by transferring the second part of the application state from the source node to the target node. The method may further comprise ascertaining that each of the first and second parts can be transferred from the source node to the target node during a single execution cycle of the application. The first part may then be transferred during a first execution cycle, and the second part during a second, subsequent execution cycle. The method may comprise splitting the application to create a plurality of decoupled parts which are able to operate independently of each other. In this way, the application is able to run on multiple different nodes in a distributed fashion. In such a case, the target node to which the first part is transferred may be different from that to which the second part is transferred. Each part of the application may be associated with a corresponding part of the application state. Splitting the application may comprise analyzing engineering data relating to the application to identify the parts which can be decoupled. The engineering data may comprise a graphic and/or narrative representation of the control logic of the application and/or its program code, especially the structured control code of the application. Identifying parts of the application which can be decoupled may comprise identifying parts of the control logic and/or code which are to some predetermined degree independent of each other, i.e. the strength of the coupling or the degree of interdependency between the parts satisfies predetermined criteria. Identifying parts of the application which can be decoupled may be performed using static analysis, e.g. static code analysis. Identifying parts of the application which can be decoupled may comprise identifying global and/or local variables, the latter being variables used by different subsystems of the distributed control system. Splitting the application may comprise using the local variables to identify splitting points. Splitting the application may comprise adding variables to one or more application parts to represent the global variables of the control logic, in the case that complete decoupling cannot be achieved. Data pertaining to the size of the additional variables may form part of the application execution profile, to be used in determining the feasibility of the transfer.

Housekeeping may be performed following the transfer. For example, the transfer management method may further comprise verifying following the transfer that the transferred application executing at the target node produces expected results. The expected results may comprise those produced by the application still executing at the source node. The transfer management method may further comprise deleting the application at the source node following the transfer.

In another implementation, transferring the application comprises updating the execution engine or firmware for executing the application at the target node. In this case, a new container with the new, updated firmware (possibly including an operating system) may be created at the target node, before the application is transferred into the new container and executed. When both containers are available, the results from both applications may be evaluated. If the results are acceptable, the old container may be deleted. In this way, it is possible to update the execution engine (including infrastructure, middleware, libraries) without stopping the application, which would negatively affect the underlying production process.

Alternatively stated, the first aspect provides a method for managing the transfer of applications comprising providing on-demand benchmarking of nodes or the network for a given application profile including e.g. application state size. The method may further comprise on-demand application monitoring to derive the application profile. Network benchmarking may comprise latency and/or bandwidth measurements. The method may comprise issuing and verifying resource reservations for the state transfer and/or execution of the transferred application.

According to a second aspect, there is provided a computing device comprising a processor configured to perform the method of the first aspect. The computing device may comprise or be comprised in a transfer manager.

According to a third aspect, there is provided a computer program product comprising instructions which, when executed by a computing device, enable or cause the computing device to perform the method of the first aspect.

According to a fourth aspect, there is provided a computer-readable medium comprising instructions which, when executed by a computing device, enable or cause the computing device to perform the method of the first aspect.

The invention may include one or more aspects, examples or features in isolation or combination whether or not specifically disclosed in that combination or in isolation. Any optional feature or sub-aspect of one of the above aspects applies as appropriate to any of the other aspects.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-implemented transfer management method for managing the transfer of a live containerized stateful process automation application from a source node to a target node of a process control system, the method comprising:
obtaining data relating to execution of the application at the source node and deriving from the data an application execution profile;
obtaining an evaluation of available computing resources at the target node;
determining feasibility of the transfer by comparing the available computing resources to the application execution profile; and
in response to the transfer being determined to be feasible, initiating the transfer of the application from the source node to the target node.

2. The method of claim 1, further comprising:
obtaining an evaluation of available network resources connecting the source node to the target node; and
obtaining latency and/or bandwidth measurements relating to communications between the source and target nodes;
wherein determining feasibility of the transfer further comprises comparing the available network resources to the application execution profile.

3. The method of claim 1, further comprising predicting one or more performance indicators relating to execution of the application at the target node.

4. The method of claim 3, wherein predicting the one or more performance indicators comprises running one or more benchmarks on the computing resources, on the network resources, or on both.

5. The method of claim 4, wherein running the one or more benchmarks comprises one or more of the following operations: run “cyclictest” to determine max jitter; run “ping/traceroot” to determine network latency; run “upower” to determine power usage; run “dd” to determine storage performance.

6. The method of claim 4, further comprising running the one or more benchmarks while running a copy of a container containing the application on the target node, without writing outputs from the copy to the process control system.

7. The method of claim 1, wherein the application execution profile specifies one or more of i) a CPU utilization of the application at the source node; ii) a memory footprint of the application at the source node; iii) an average cycle time of an execution engine at the source node; iv) jitter at the source node execution engine; v) a size of a state of the application; vi) execution priority; vii) a configuration of the application; viii) offset.

8. The method of claim 1, wherein initiating the transfer comprises issuing resource reservations for the transfer, wherein issuing resource reservations comprises issuing a computing resource reservation to the target node to reserve computing resources for execution of the application following the transfer and issuing a network resource reservation to a network management system to reserve network resources for the transfer.

9. The method of claim 8, further comprising verifying that the resources have been reserved before determining that the transfer is feasible.

10. The method of claim 1, wherein the transfer comprises transferring a state of the application.

11. The method of claim 10, wherein transferring the state of the application comprises introducing one or more alterations to the state during the transfer.

12. The method of claim 1, wherein the transfer comprises handing over execution of the application from the source node to the target node without stopping the execution.

13. The method of claim 1, wherein transferring the application comprises updating the firmware of a container for executing the application at the target node.

14. A computing device comprising a processor, the processor configured to execute computer executable instructions stored in a tangible medium, wherein execution of the computer executable instructions causes execution of a transfer management method for managing the transfer of a live containerized stateful process automation application from a source node to a target node of a process control system, the method comprising:
obtaining data relating to execution of the application at the source node and deriving from the data an application execution profile;
obtaining an evaluation of available computing resources at the target node;
determining feasibility of the transfer by comparing the available computing resources to the application execution profile; and
in response to the transfer being determined to be feasible, initiating the transfer of the application from the source node to the target node.

15. The computing device of claim 11, wherein the method further comprises:
obtaining an evaluation of available network resources connecting the source node to the target node; and
obtaining latency and/or bandwidth measurements relating to communications between the source and target nodes;
wherein determining feasibility of the transfer further comprises comparing the available network resources to the application execution profile.

16. The computing device of claim 14, wherein the method further comprises predicting one or more performance indicators relating to execution of the application at the target node.

17. The computing device of claim 16, wherein predicting the one or more performance indicators comprises running one or more benchmarks on the computing resources, on the network resources, or on both.

18. The computing device of claim 17, wherein running the one or more benchmarks comprises one or more of the following operations: run “cyclictest” to determine max jitter; run “ping/traceroot” to determine network latency; run “upower” to determine power usage; run “dd” to determine storage performance.

19. The computing device of claim 18, wherein the method further comprises running the one or more benchmarks while running a copy of a container containing the application on the target node, without writing outputs from the copy to the process control system.

20. The computing device of claim 14, wherein initiating the transfer comprises issuing resource reservations for the transfer, wherein issuing resource reservations comprises issuing a computing resource reservation to the target node to reserve computing resources for execution of the application following the transfer and issuing a network resource reservation to a network management system to reserve network resources for the transfer.
